(19) United States
(12) Patent Application Publication
(10) Pub. No.: US 2026/0152236 A1
(43) Pub. Date: Jun. 4, 2026

(54) VEHICLE FRAME STRUCTURE

(71) Applicant: TOYOTA JIDOSHA KABUSHIKI KAISHA, Toyota-shi (JP)

(72) Inventors: Katsuhiro SAKURAI, Toyota-shi (JP); Koji MATSUEDA, Toyota-shi (JP)

(73) Assignee: TOYOTA JIDOSHA KABUSHIKI KAISHA, Toyota-shi (JP)

(21) Appl. No.: 19/387,226

(22) Filed: Nov. 12, 2025

(30) Foreign Application Priority Data
Nov. 29, 2024 (JP) 2024-208925

(51) Int. Cl. B62D 25/08

(52) U.S. Cl. CPC B62D 25/085

(57) ABSTRACT

The draft angle in a mount portion provided on the inner surface of a vertical wall of a cast body is smaller than the draft angle of a general portion. The outer surface of the vertical wall is formed substantially parallel to the inner surface of the vertical wall. This allows a fastening tool used to fasten a bolt to be applied at a smaller approach angle with respect to a reference line along a vehicle width direction. As a result, the possibility of interference between the fastening tool and ribs can be reduced. Specifically, the possibility of such interference can be reduced without partially cutting away the ribs. Accordingly, rigidity desired for a front portion of a vehicle can be ensured, and bolts can be fastened to a mount portion of a motor unit.

### CROSS-REFERENCE TO RELATED APPLICATION

This application claims priority to Japanese Patent Application No. 2024-208925 filed on Nov. 29, 2024. The disclosure of the above-identified application, including the specification, drawings, and claims, is incorporated by reference herein in its entirety.

### BACKGROUND

### 1. Technical Field

The present disclosure relates to vehicle frame structures.

### 2. Description of Related Art

Japanese Unexamined Patent Application Publication No. 2013-177902 (JP 2013-177902 A) discloses a technique for bolting an engine to an engine mount bracket integrally formed with an aluminum die-cast chain case. In this related art, it is considered possible to reduce manufacturing costs and weight by integrally forming the chain case and the engine mount bracket.

### SUMMARY

Generally, when a vehicle frame member is manufactured by die casting, ribs etc. extending along the draft direction are formed on the vehicle frame member in order to ensure the rigidity of the vehicle frame member. Moreover, a draft angle for facilitating removal from the die is provided on the vehicle frame member.

When a bolt fastening surface is provided along the draft angle on the vehicle frame member, it is desired to reduce the height of the ribs in order to reduce the possibility of interference with the ribs during insertion of a fastening tool for fastening a bolt. This may lead to a reduction in rigidity of the vehicle frame member.

In view of the above circumstances, an object of the present disclosure is to provide a vehicle frame structure including a vehicle frame member that is formed by die casting, ensures desired rigidity, and allows bolt fastening.

A vehicle frame structure of a first aspect includes a vehicle frame member provided by die casting. The vehicle frame member is provided outward of a motor unit in a vehicle width direction and extending in a vehicle front-rear direction. The motor unit is disposed in a front or rear portion of a vehicle and configured to drive a wheel. The vehicle frame member includes: a vertical wall provided on a side facing the motor unit, and extending in the vehicle front-rear direction and a vehicle up-down direction; a plurality of ribs extending outward in the vehicle width direction from the vertical wall; and a through hole provided within a region of the vertical wall surrounded by the ribs. The through hole is configured to receive a fastening member that fastens the motor unit. A release direction from a die used to provide the vehicle frame member is set along the vehicle up-down direction. On an inner surface that defines the inner side of the vertical wall in the vehicle width direction, a draft angle in a portion around the through hole is smaller than a draft angle in a general portion other than the portion around the through hole.

The vehicle frame structure of the first aspect includes the vehicle frame member provided outward of the motor unit in the vehicle width direction, and the motor unit is disposed in the front or rear portion of the vehicle and is configured to drive the wheel. The vehicle frame member extends in the vehicle front-rear direction, and is provided by die casting.

The vehicle frame member includes the vertical wall, the ribs, and the through hole. The vertical wall is provided on the side of the vehicle frame member facing the motor unit, and extends in the vehicle front-rear direction and the vehicle up-down direction. The ribs extend outward in the vehicle width direction from the vertical wall. In addition, the through hole is provided within a region of the vertical wall surrounded by the ribs.

The ribs are thus formed in the portion around the through hole. This can improve rigidity of the vertical wall. Furthermore, the fastening member is inserted through the through hole, and the motor unit is fastened to the vehicle frame member via the fastening member and the vertical wall.

In this aspect, the vehicle frame member is provided by die casting. On the inner surface that defines the inner side of the vertical wall in the vehicle width direction, the release direction from the die used to provide the vehicle frame member is set along the vehicle up-down direction, and the draft angle in the portion around the through hole is smaller than the draft angle in the general portion other than the portion around the through hole.

Considering the fastening strength by the fastening member, the outer surface of the vertical wall is formed substantially parallel to the inner surface of the vertical wall in accordance with the draft angle on the inner surface of the vertical wall. In this aspect, on the inner surface of the vertical wall, the draft angle in the portion around the through hole is smaller than the draft angle in the general portion (comparative example). This allows a fastening tool (such as an impact wrench) used to fasten the fastening member to be applied at a smaller approach angle with respect to a reference line along the vehicle width direction, compared to the comparative example.

As a result, in this aspect, the possibility of interference between the fastening tool and the ribs can be reduced. Specifically, the possibility of such interference can be reduced without partially cutting away the ribs such as reducing the height of the ribs. Since the ribs are not cut away, the rigidity desired for the vehicle frame member provided by die casting can be ensured.

According to a vehicle frame structure of a second aspect, in the vehicle frame structure of the first aspect, in the portion around the through hole, an outer surface that defines the outer side of the vertical wall in the vehicle width direction is provided at substantially the same angle as the draft angle of the inner surface.

In the vehicle frame member, the vertical wall extends in the vehicle front-rear direction and the vehicle up-down direction, and the ribs extend outward in the vehicle width direction from the vertical wall. Since the release direction of the vehicle frame member from the die is set along the vehicle up-down direction, the outer surface of the vertical wall is formed by a slide die that moves outward in the vehicle width direction. Accordingly, a so-called draft angle may not be provided on the outer surface of the vertical wall.

In the vehicle frame structure of the second aspect, the outer surface that defines the outer side of the vertical wall in the vehicle width direction is provided at substantially the same angle as the draft angle of the inner surface of the vertical wall. This allows the axial force of the fastening member to be applied substantially perpendicularly to the surface to which the fastening member is fastened. Accordingly, fastening strength can be improved.

According to a vehicle frame structure of a third aspect, in the vehicle frame structure of the first or second aspect, part of the ribs is provided on the portion around the through hole.

In the vehicle frame structure of the third aspect, part of the ribs is provided in the portion around the through hole. This can improve the rigidity in the portion around the through hole.

As described above, the vehicle frame structure according to the present disclosure is formed by die casting, and has an excellent effect that it ensures the desired rigidity and allows bolt fastening.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle frame structure according to an embodiment of the present disclosure is applied, as viewed obliquely from the front left and above;

FIG. 2 is an exploded perspective view of the vehicle to which the vehicle frame structure according to the embodiment is applied, as viewed obliquely from the front left and above;

FIG. 3 is an enlarged perspective view of a main portion in FIG. 2;

FIG. 4 is a side view of the vehicle to which the vehicle frame structure according to the embodiment is applied;

FIG. 5 is a schematic sectional view taken along line A-A in FIG. 4; and

FIG. 6 is a partial enlarged sectional view taken along line B-B in FIG. 2.

### DETAILED DESCRIPTION OF EMBODIMENTS

Hereinafter, a vehicle frame structure according to an embodiment of the present disclosure will be described with reference to the drawings. In the drawings, an arrow FR indicates the front side in the vehicle front-rear direction, and an arrow UP indicates the upper side in the vehicle up-down direction. An arrow RH indicates the right side in the vehicle width direction, and an arrow LH indicates the left side in the vehicle width direction. Hereinafter, the terms “front,” “rear,” “upper,” “lower,” “left,” and “right” refer to front and rear in the vehicle front-rear direction, upper and lower in the vehicle up-down direction, and left and right in the vehicle left-right direction (vehicle width direction), respectively, unless otherwise specified.

### Configuration of Vehicle Frame Structure

First, the configuration of the vehicle frame structure according to the embodiment will be described.

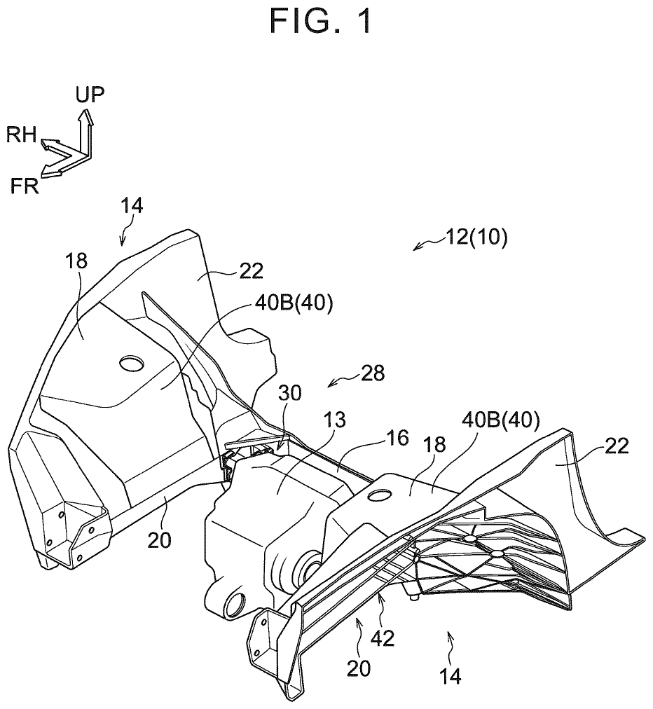

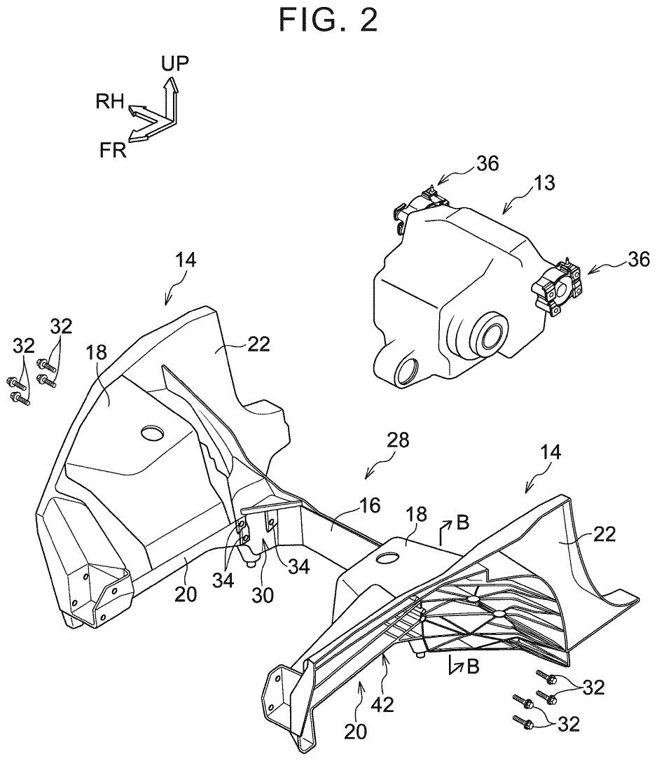

FIGS. 1 and 2 show a front portion (vehicle front portion) 12 of a vehicle 10 to which the vehicle frame structure of the present embodiment is applied. The vehicle 10 is, for example, a battery electric vehicle or fuel cell electric vehicle that runs on power generated by a motor unit 13. As shown in FIGS. 1 and 2, wheel houses 14 in which right and left front wheels (not shown) are respectively disposed extend in the vehicle front-rear direction in the vehicle front portion 12. The right and left wheel houses 14 are connected by a cross member 16 extending in the vehicle width direction.

A suspension tower 18 is provided on the inner side of each wheel house 14 in the vehicle width direction. Each suspension tower 18 supports the upper end of a corresponding one of front-wheel suspensions. A front side member 20 extending in the vehicle up-down direction and the vehicle front-rear direction is provided below each suspension tower 18. A front pillar 22 extending in the vehicle up-down direction and the vehicle front-rear direction is provided on the rear side of each wheel house 14.

In the present embodiment, for example, the pair of right and left wheel houses 14 including the suspension towers 18 and the front side members 20, the cross member 16, and the front pillars 22 are integrally formed by die casting using a material such as an aluminum alloy or a magnesium alloy (cast body 28). In the present embodiment, the cast body 28 has a substantially U-shape that is open toward the front of the vehicle, as viewed in plan.

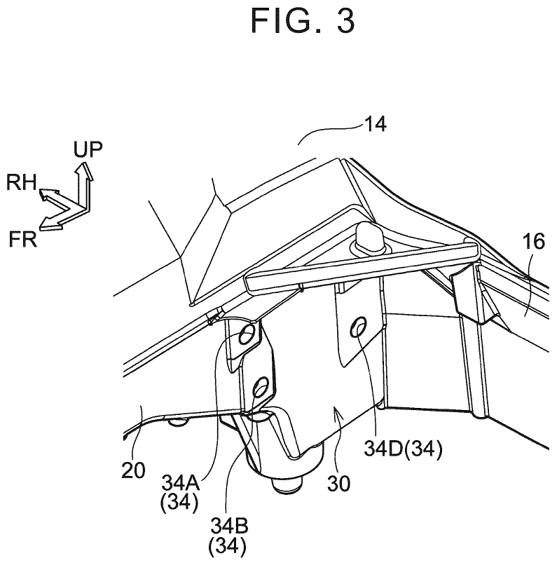

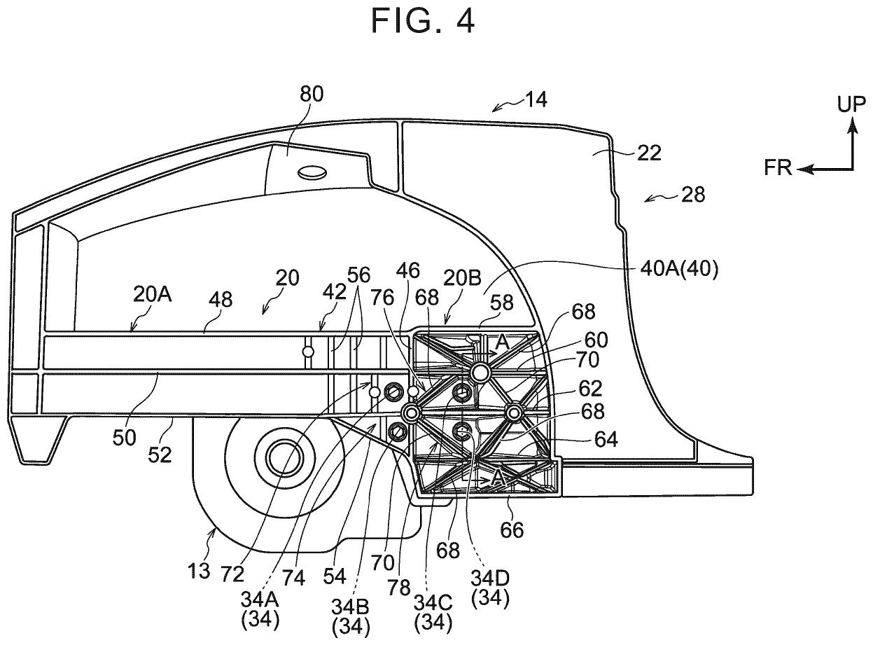

In the present embodiment, a mount portion (portion around a through hole) 30 is provided at each of the locations where the right and left wheel houses 14 and the cross member 16 are connected. An enlarged view of the mount portion 30 is shown in FIG. 3. As shown in FIG. 3, the mount portion 30 has through holes 34 through which bolts (fastening members) 32 can be inserted. FIG. 4 is a side view of the vehicle 10. Although there are four through holes 34 in this example, only three of them are shown in FIG. 3 due to the viewing angle of the vehicle front portion 12.

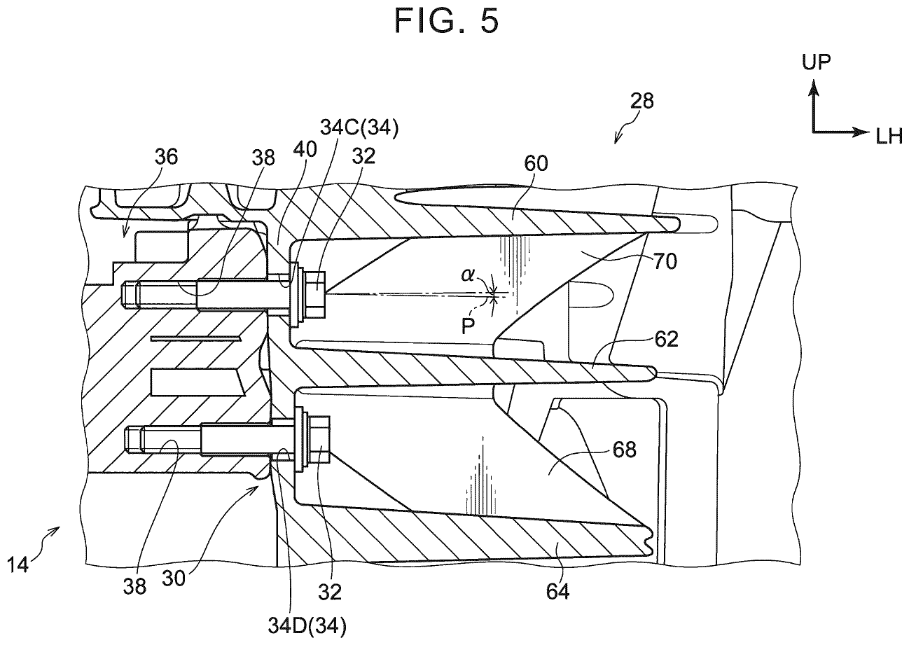

As shown in FIGS. 2 and 5, the motor unit 13 is provided with mount portions 36 each fastened to a corresponding one of the mount portions 30 of the cast body 28. Each mount portion 36 has fastening holes 38 into which the bolts 32 are screwed.

Therefore, in the present embodiment, the bolts 32 inserted through the through holes 34 in each mount portion 30 of the cast body 28 are screwed (fastened) into the fastening holes 38 in a corresponding one of the mount portions 36 of the motor unit 13. The motor unit 13 is thus installed (i.e., mounted) on the cast body 28. FIG. 5 is a sectional view taken along line A-A in FIG. 4.

Each of the right and left wheel houses 14 is provided with a suspension member (not shown). A front member extends in the vehicle width direction between the suspension members, and a mount portion is provided at the center of the front member in the extending direction of the front member. The motor unit 13 is thus supported at three points including this mount portion.

As shown in FIGS. 2 and 4, each wheel house 14 includes a vertical wall 40 that extends in the vehicle front-rear direction and the vehicle up-down direction. A plurality of ribs 42 extends along the vehicle width direction from a surface 40A on the outer side of the vertical wall 40 (the outer surface 40A of the vertical wall 40) in the vehicle width direction.

As described above, in the present embodiment, the right and left wheel houses 14 and the cross member 16 are integrally formed as the cast body 28 by die casting. For example, although not shown in the drawings, a die used to form the cast body 28 includes a movable die that moves along the vehicle up-down direction relative to a fixed die, thereby allowing the die to be opened and closed. In addition, a slide core moves along the vehicle width direction in accordance with the opening and closing of the die, in order to form the outer side of the cast body 28 in the vehicle width direction.

Therefore, it is desired to provide a so-called draft angle on the surface of the cast body 28 along the moving direction of the die. The draft angle is set in advance based on the material of the cast body 28, the length in the draw direction, etc.

In the present embodiment, for example, an inner surface 40B that defines the inner side of the vertical wall 40 in the vehicle width direction (the side facing the motor unit 13) is formed by the fixed and movable dies, and the outer surface 40A of the vertical wall 40, including the ribs 42, is formed by the slide core.

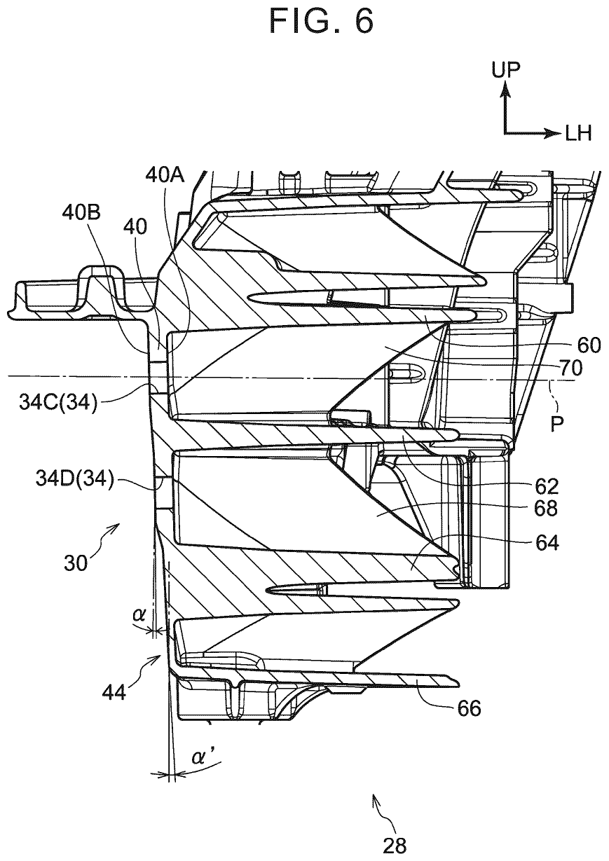

As described above, in the present embodiment, the cast body 28 is provided with the mount portions 30 to which the motor unit 13 is fastened. Each mount portion 30 is provided on a corresponding one of the vertical walls 40 of the cast body 28. As shown in FIG. 6, on the inner surface 40B of each vertical wall 40, the draft angle α in the mount portion 30 is different from the draft angle α′ (e.g., approximately 3° in this example) in a general portion 44 other than the mount portion 30.

That is, in the present embodiment, the draft angle α in the mount portion 30 is smaller than the draft angle α′ in the general portion 44 (α<α′). FIG. 6 is a sectional view taken along line B-B in FIG. 2. In the present embodiment, the outer surface 40A of the vertical wall 40 is formed substantially parallel to the inner surface 40B of the vertical wall 40, in accordance with the draft angle α of the inner surface 40B of the vertical wall 40.

As shown in FIG. 4, the ribs 42 are formed on the outer surface 40A of the vertical wall 40 so as to extend outward in the vehicle width direction. FIG. 4 mainly shows the ribs 42 in a region around the mount portion 30.

The ribs 42 extending from the outer surface 40A of the vertical wall 40 will now be described in detail. In the present embodiment, the front side member 20 of the cast body 28 is divided into a front portion 20A and a rear portion 20B along the vehicle front-rear direction. The front portion 20A and the rear portion 20B are separated by a partition wall (rib) 46 extending in the vehicle up-down direction and the vehicle width direction. The rear portion 20B protrudes downward beyond the front portion 20A.

An upper wall (rib) 48 is provided on the front portion 20A of the front side member 20. The upper wall 48 forms the upper end of the front portion 20A of the front side member 20, and extends in the vehicle front-rear direction and the vehicle width direction. A horizontal wall (rib) 50 is provided below the upper wall 48. The horizontal wall 50 extends in the vehicle front-rear direction and the vehicle width direction and substantially parallel to the upper wall 48. Furthermore, a lower wall (rib) 52 is provided below the horizontal wall 50. The lower wall 52 forms the lower end of the front portion 20A of the front side member 20, and extends in the vehicle front-rear direction and the vehicle width direction and substantially parallel to the horizontal wall 50.

An inclined wall 54 gradually sloping downward in the vehicle up-down direction toward the rear of the vehicle is provided at the rear end portion of the lower wall 52. The inclined wall 54 is connected to the partition wall 46. A plurality of vertical ribs 56 is provided along the vehicle up-down direction between the upper wall 48 and the horizontal wall 50, and between the horizontal wall 50 and the lower wall 52.

An upper wall (rib) 58 is provided on the rear portion 20B of the front side member 20. The upper wall 58 is connected to the upper wall 48 on the front portion 20A of the front side member 20, forms the upper end of the rear portion 20B of the front side member 20, and extends in the vehicle front-rear direction and the vehicle width direction. Horizontal walls (ribs) 60, 62 are provided below the upper wall 58. The horizontal walls 60, 62 are respectively connected to the horizontal wall 50 and the lower wall 52 on the front portion 20A of the front side member 20, and extend in the vehicle front-rear direction and the vehicle width direction.

Furthermore, a horizontal wall (rib) 64 is provided below the horizontal wall 62. The horizontal wall 64 extends in the vehicle front-rear direction and the vehicle width direction and substantially parallel to the horizontal wall 62. A lower wall (rib) 66 is provided below the horizontal wall 64. The lower wall 66 forms the lower end of the rear portion 20B of the front side member 20, and extends in the vehicle front-rear direction and the vehicle width direction and substantially parallel to the horizontal wall 64.

A plurality of upward-sloping ribs (ribs) 68 and a plurality of downward-sloping ribs (ribs) 70 are provided between the upper wall 58 and the horizontal wall 60, between the horizontal walls 60, 62, between the horizontal walls 62, 64, and between the horizontal wall 64 and the lower wall 66. The upward-sloping ribs 68 gradually slope upward in the vehicle up-down direction toward the rear of the vehicle. The downward-sloping ribs 70 gradually slope downward in the vehicle up-down direction toward the rear of the vehicle. The upward-sloping ribs 68 and the downward-sloping ribs 70 are provided continuously, forming an apparent truss structure together with the upper wall 58, the horizontal walls 60, 62, 64, and the lower wall 66.

As described above, each mount portion 30 of the cast body 28 has four through holes 34. Of the four through holes 34, through holes 34A, 34B located on the front portion 20A side of the mount portion 30 are disposed in the front portion 20A of the front side member 20. Through holes 34C, 34D located on the rear portion 20B side of the mount portion 30 are disposed in the rear portion 20B of the front side member 20.

The shape of the ribs 42 provided on the portion around the through hole 34 is different between the through holes 34A, 34B and the through holes 34C, 34D. The through hole 34A is provided within a rectangular rib 72 formed by the horizontal wall 50, the lower wall 52, the vertical rib 56, and the partition wall 46. The through hole 34B is provided within a rectangular rib 74 formed by the lower wall 52, the inclined wall 54, the vertical rib 56, and the partition wall 46.

On the other hand, the through hole 34C is provided within a truss-shaped rib 76 formed by the horizontal walls 60, 62, the upward-sloping rib 68, and the downward-sloping rib 70. The through hole 34D is provided within a truss-shaped rib 78 formed by the horizontal walls 62, 64, the downward-sloping rib 70, and the upward-sloping rib 68.

In the present embodiment, as shown in FIG. 5, the bolts 32 are inserted through the through holes 34 formed in the mount portion 30 of the cast body 28, and are screwed into the fastening holes 38 formed in the mount portion 36 of the motor unit 13. The bolts 32 are fastened into the fastening holes 38 using a fastening tool such as an impact wrench. Functions and Effects of Vehicle Frame Structure

Next, functions and effects of the vehicle frame structure according to the present embodiment will be described.

In the present embodiment, as shown in FIGS. 1 to 3, the vehicle front portion 12 to which the vehicle frame structure is applied is formed by die casting. The cast body 28 includes the vertical walls 40, the ribs 42, and the through holes 34.

Each vertical wall 40 is formed on the side facing the motor unit 13 in the vehicle front portion 12, and extends in the vehicle front-rear direction and the vehicle up-down direction. The ribs 42 extend outward in the vehicle width direction from the vertical wall 40. Furthermore, the through holes 34 are provided in the vertical wall 40, and are each formed within a corresponding one of the regions surrounded by the ribs 42.

To briefly describe the through holes 34 and the ribs 42, the through holes 34A, 34B in the mount portion 30 are respectively provided within the rectangular ribs 72, 74, and the through holes 34C, 34D in the mount portion 30 are respectively provided within the truss-shaped ribs 76, 78. In the present embodiment, the ribs 42 are provided in the portions around the through holes 34 in this manner, which can improve the rigidity of the vertical wall 40.

The bolts 32 are inserted through the through holes 34, and the mount portion 36 of the motor unit 13 is fastened via the bolts 32 and the vertical wall 40 to the mount portion 30 of the cast body 28 that constitutes the vehicle front portion 12.

In the present embodiment, on the inner surface 40B (the side facing the motor unit 13) that defines the inner side of the vertical wall 40 in the vehicle width direction, the release direction from the die used to form the vehicle front portion 12 is set along the vehicle up-down direction, and the draft angle α in the mount portion 30 is smaller than the draft angle α′ in the general portion 44 (α<α′). The outer surface 40A of the vertical wall 40 is formed substantially parallel to the inner surface 40B of the vertical wall 40, in accordance with the draft angle α of the inner surface 40B of the vertical wall 40.

In the present embodiment, on the inner surface 40B of the vertical wall 40, the draft angle α in the portion around the through hole 34 is smaller than the draft angle α′ in the general portion 44. This allows a fastening tool (such as an impact wrench) used to fasten the bolts 32 to be applied at a smaller approach angle (α) with respect to a reference line P along the vehicle width direction, compared to the comparative example.

As a result, in the present embodiment, the possibility of interference between the fastening tool and the ribs 42 can be reduced. Specifically, the possibility of such interference can be reduced without partially cutting away the ribs 42 such as reducing the height of the ribs 42. Since the ribs 42 are not cut away, the rigidity desired for the vehicle front portion 12 can be ensured.

That is, in the present embodiment, the mount portions 30 of the vertical walls 40 of the cast body 28 formed by die casting are ensured to have the rigidity desired to mount the motor unit 13. Accordingly, in the present embodiment, it is possible to directly fasten bolts to the mount portions 36 of the motor unit 13 without providing spacers etc. for ensuring the rigidity.

In the present embodiment, the outer surface 40A of the vertical wall 40 is formed at substantially the same angle as the draft angle α of the inner surface 40B of the vertical wall 40. This allows the axial force of the bolt 32 to be applied substantially perpendicularly to the surface to which the bolt 32 is fastened (outer surface 40A). Fastening strength can therefore be improved.

The above embodiment illustrates an example in which the vehicle frame structure is applied to the vehicle front portion 12. However, it should be understood that the vehicle frame structure may be applied to a vehicle rear portion.

It should also be understood that the present disclosure is not limited to the above embodiment and may be carried out in various forms without departing from the spirit and scope of the present disclosure.

What is claimed is:

1. A vehicle frame structure comprising a vehicle frame member provided by die casting, the vehicle frame member being provided outward of a motor unit in a vehicle width direction and extending in a vehicle front-rear direction, the motor unit being disposed in a front or rear portion of a vehicle and configured to drive a wheel, wherein:
the vehicle frame member includes
a vertical wall provided on a side facing the motor unit, and extending in the vehicle front-rear direction and a vehicle up-down direction,
a plurality of ribs extending outward in the vehicle width direction from the vertical wall, and
a through hole provided within a region of the vertical wall surrounded by the ribs, the through hole being configured to receive a fastening member that fastens the motor unit; and
a release direction from a die used to provide the vehicle frame member is set along the vehicle up-down direction, and on an inner surface that defines an inner side of the vertical wall in the vehicle width direction, a draft angle in a portion around the through hole is smaller than a draft angle in a general portion other than the portion around the through hole.

2. The vehicle frame structure according to claim 1, wherein in the portion around the through hole, an outer surface that defines an outer side of the vertical wall in the vehicle width direction is provided at substantially the same angle as the draft angle of the inner surface.

3. The vehicle frame structure according to claim 1, wherein part of the ribs is provided on the portion around the through hole.
